(19) United States
(12) Patent Application Publication
(10) Pub. No.: US 2010/0005224 A1
(43) Pub. Date: Jan. 7, 2010

(54) Foldable USB flash memory device that can be manufactured in any desired shape and size suitable for different types of host devices

(76) Inventor: Ram Gupta, (US)

Correspondence Address: Ram Gupta, 5989 Countess Dr., San Jose, CA, 95129, US

(21) Appl. No.: 12/168,157

(22) Filed: Jul. 7, 2008

(51) Int. Cl. G06F 12/02; G06F 12/00

(52) U.S. Cl. 711/103; 711/115; 711/E12.001; 711/E12.008

(57) ABSTRACT

An enhanced design for the USB flash memory devices implemented with the USB specifications. The main idea in this design is to create two-section USB flash memory devices and both the sections be joined together with the help of rotating hinges and pivots so that both the sections can rotate with respect to each other. In this design, one section contains the USB connector that is used to connect the USB device with the host device and the other section contains the USB controller, memory controller, and flash memory components of a standard USB device. This arrangement provides the ability to both the sections in the device to rotate against each other and adjust at any desired angle and be folded together. While the rotating hinges are required at both the end sides of two sections where both the sections join together to be able to rotate around each other, rotating hinges or ribbon cables are used between the two sections to provide path for the data flow and the required power between the USB flash memory device and the USB host.

A USB flash memory device generally consists of a USB connector, USB controller, memory controller, and one or more flash memory modules. USB connector is used to connect the USB flash memory device with the host device and provides a path for data transfer and the required power needed to operate the device. USB controller is used to control the data flow between the USB flash memory and the USB connector. A USB flash memory device can store any type of data such as text, binary, audio, video, and multi-media files. An example of the USB flash memory is available in U.S. Pat. No. 6,148,354.

### DESCRIPTION OF THE INVENTION

1) FIG. 1 depicts a consumer view of two-section USB flash memory device. As shown in FIG. 1, this design provides a USB flash memory device consisting of two sections labeled as 1 and 2. Section#1 (labeled as 1) of the claimed two-section design works as a USB connector and majority of this section gets inserted into the USB port on the host devices. The second section (labeled as 2) of the device houses USB controller, memory controller, one or more flash memory modules, and optionally an standard LCD display window to indicate the usage of the USB flash memory. Middle portion in the design that is labeled as 3 depicts the portion between sections 1 and 2 and contains two hinges on the two corners and four middle hinges in between the two corner hinges. The hinges allow section#2 to rotate around section#1. Four middle hinges in section#3 provide the path for the data in and out of memory and the required power for the device, they also assist section#2 to rotate around section#1.

2) Generally there is only as much part of section#1 that gets extended out which is sufficient to mount the section#2 on it. Section#2 that gets mounted on the section#1 of the device can be rotated in the upward or downward directions relative to the surface of section#1 and be adjusted to make it adjacent to the host device's surface. This arrangement virtually makes the foldable two-section flash memory devices with this design to look as an integral part of the host device. FIG. 3 depicts how section#2 can be rotated around section#1 in a two-section flash memory device.

3) Section#2 can be customized in any shape and size to suit the availability of the free surrounding space around the USB ports that might vary for different types of hosts. Section#2 can also be of made of any desired thickness.

4) The four middle hinges in the two section foldable USB devices can be of cylindrical or ring shape. These four middle hinges can be completely replaced with the flexible ribbon cables as well. Usage of cylindrical and ring shaped hinges and ribbon cables that provide the USB connectivity between sections #1 and #2 represent three distinct claimed designs.

### DESCRIPTION OF THE DRAWINGS

1) FIG. 1 shows a view of the claimed design of a two-section USB flash memory device. This diagram shows two sections labeled as 1 and 2, which are connected to each other with cylindrical hinges and pivots that are shown in the middle portion of the diagram labeled as 3. Hinges and pivots which are shown in the portion labeled as 3 provide the ability to the sections 1 and 2 to rotate around each other, and fold on to each other. The FIG. 1 represents the design#1 of the three designs claimed in this invention.

2) FIG. 2 depicts the detailed view of the claimed design along with the standard components of a USB flash drive. Section#1 in the claimed design of USB flash memory device is designed with two layers of an appropriate substrate, which is light in weight, flexible, non-conductive, and sturdy. Portion of the USB connectors where they have become narrower in width labeled as 35, 36, 37, 38 are sandwiched between the two layers of the substrate that forms section#1. Portion of the USB connectors labeled as 35, 36, 37, 38 can be narrower at the joints in comparison to their front portions.
The section which is labeled as 2 is Section#2 and it includes the portions of the USB connectors labeled as 31, 32, 33, and 34. These USB connectors in section#2 are joined with the USB connectors 35, 36, 37, and 38 of section#1 with the help of hinges which have capability to rotate around the pivots. Rivets made of appropriate metals can be used in the joints to fasten the joints.
Section#1 is the USB connector of the claimed design of two-section USB flash memory that connects the device with the host devices.
Section#2 includes the standard USB memory device components such as USB Controller, Memory Controller, and Flash Memory Module.

3) FIG. 3 depicts how section#2 can be rotated around section#1 to make the two-section USB flash memory device adjust at any desired angle or to fold on their surface.

4) FIG. 4 is a re-production of FIG. 1 to demonstrate the claimed design in detail.
a) Parts labeled as 53, 54, 55, 56 are the standard USB pin connectors. Part labeled as 67 is the standard raised surface on each of the pin connectors that help the pins to make a better connection with the USB ports in USB hosts.
b) The parts labeled as 41 and 42 are the hollow cylinders extending from the bodies of section#1 and section#2. With the help of a rivet that goes through both 41 and 42, they convert into a hinge on this corner. Similarly parts 51 and 52 with the help of a rivet form a hinge on the other corner. These two hinges make the section#1 and section#2 to rotate around each other's surface and make them be able to fold on each other's surface.
c) The parts labeled as 43, 44, 45, 46, 47, 48, 49, and 50 are the hollow cylinders that are used to join the four USB conductor pins between sections#1 and 2, and facilitate the formation of two-section flash memory devices. Parts 44, 46, 48, and 50 are the hollow cylinders formed at the USB conductor pins extending out of section#1. Parts 43, 45, 47, and 49 are the hollow cylinders formed at the USB conductor pins extending out of section#2. Cylindrical pairs of parts 43 and 44, 45 and 46, 47 and 48, and 49 and 50 with the help of rivets that pass through each of them make them joint and at the same time these pairs work as the hinges.
d) Formation of the hinges described in the above sections b) and c) create the design of two-section flash memory devices.

5) FIG. 5 depicts the details of two hinges that are manufactured on the two side corners of section#1 and section#2 to mount the sections together and make them rotate around each other. These hinges are attached to the bodies of the section#1 and section#2. Parts labeled as 81 and 82 make the pivots that pass through the cylindrical extensions from sections #1 and #2 and form the hinges at the two side corners.

6) FIG. 6 depicts a representation of a pivot. In this arrangement the USB connectors are split in the middle and joined together with the pivots labeled as 81 and 82, which makes both the USB connector parts to be able to rotate around the pivots. These joints between section#1 and section#2 provide the path for the data flow and power required by the two-section USB flash memory device. The portions of the USB connectors at and around the joint may be made narrower than the end parts. The joint portions of the USB conductors are given cylindrical shapes so that a pivot can be passed through them and be fastened on both the ends.

7) FIG. 7 depicts the design#2 for the joint portion of the USB conductors. Instead of the USB connectors forming cylindrical shapes at the joints, this design provides thin rings labeled as 51 and 52 that are connected to the USB connectors via thin wires labeled as 54 and 53. These rings in turn are joined together with pivots labeled as 83 and 84 that make them to be able to rotate.

8) FIG. 8 depicts the usage of flexible ribbon cables in place of the four middle hinges that provide the path for the data flow and power required by the two-section USB flash memory device. Parts labeled 90, 91, 92, and 93 are flexible thin conductive wires wrapped around with flexible plastic like substrate to form the ribbon cable. Ribbon cables have flexibility to rotate along with the corner hinges to facilitate both the sections to rotate around each other in upward or downward directions.

9) FIG. 9 depicts a detailed level view of the foldable USB memory device that is using the flexible ribbon cable instead of the four middle hinges in between the sections #1 and #2.

10) FIG. 10 depicts the detailed view of a thin wire wrapped with plastic material that is used to form a ribbon cable. Four such wires are used to form a ribbon cable that is used in the foldable USB device. Part 95 is a flexible thin and conductive wire which is wrapped around by the plastic material layers labeled as 94.

11) FIG. 11 depicts a foldable USB memory device that is using the ribbon cable to join the sections #1 and #2.

12) FIG. 12 depicts the section 3 of the foldable USB memory device that is using the ribbon cable.

13) FIG. 13 depicts the usage of a standard one-section USB flash memory device labeled as 85 and that it is being extended out of the host device, in this case a laptop computer. It shows that this extended USB flash memory drive occupies outside space and may pose inconvenience to the users.

14) FIG. 14 shows the usage of two-section foldable USB flash memory device of claimed design labeled as 86 with section#1 completely inserted in the USB port of the host device and section#2 being able to rotate around section#1 in the up or down directions.

FIG. 15 shows the usage of claimed two-section foldable USB flash memory device labeled as 86 with section#1 completely inserted in the USB port of the host device and section#2 being rotated until it rests with the body surface of the laptop. This figure shows that the two-section USB memory drive has pretty much become an integral part of this laptop.

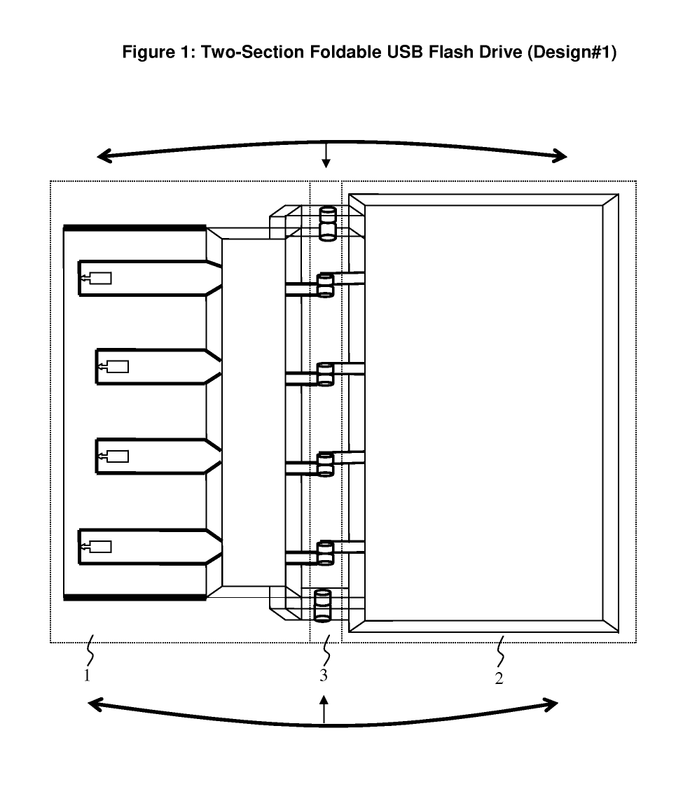

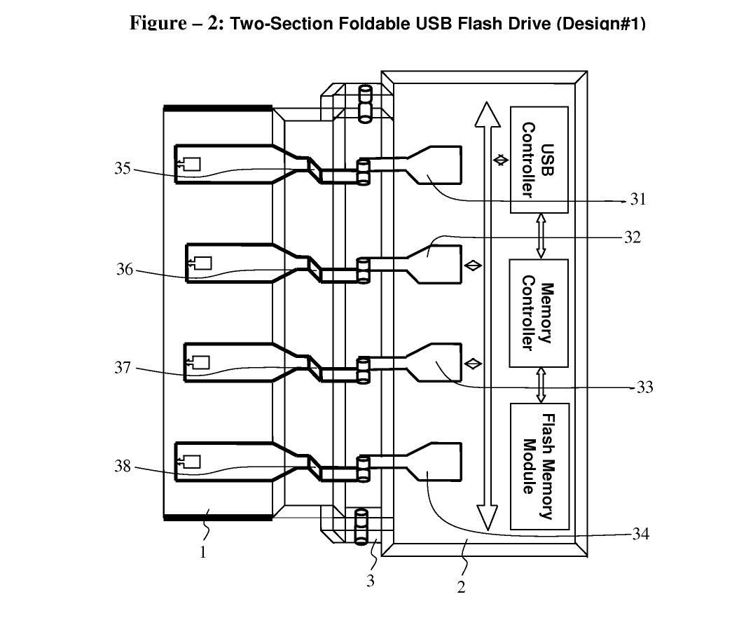

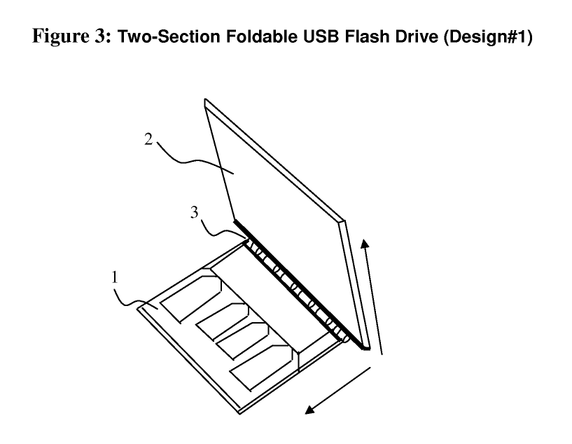

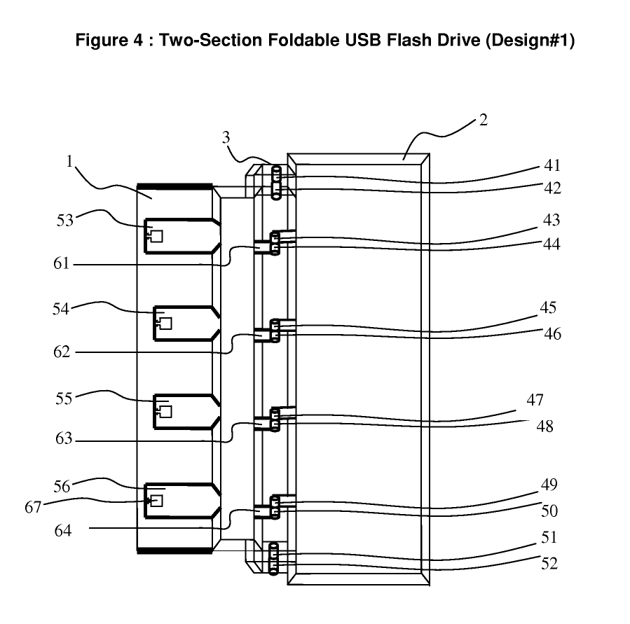

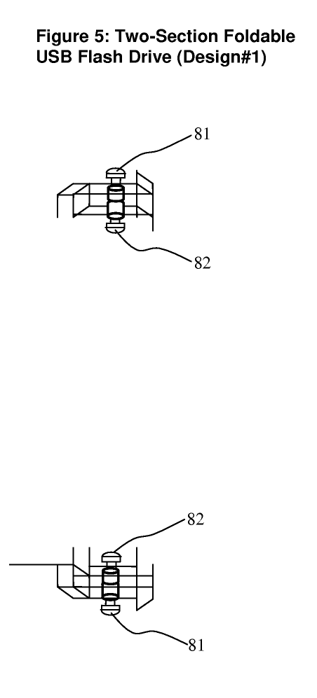

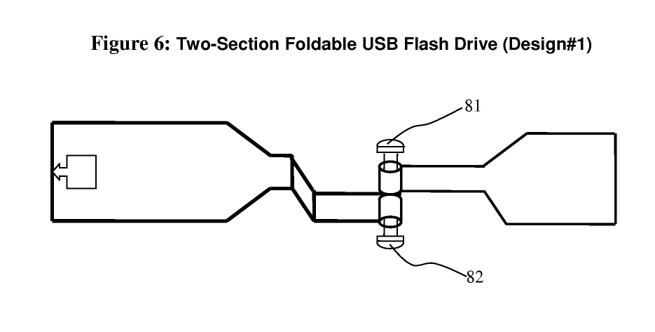

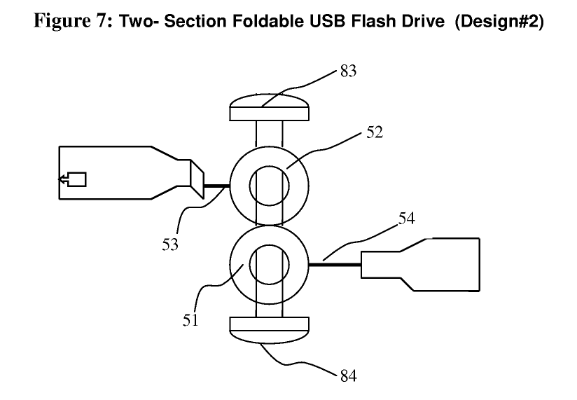

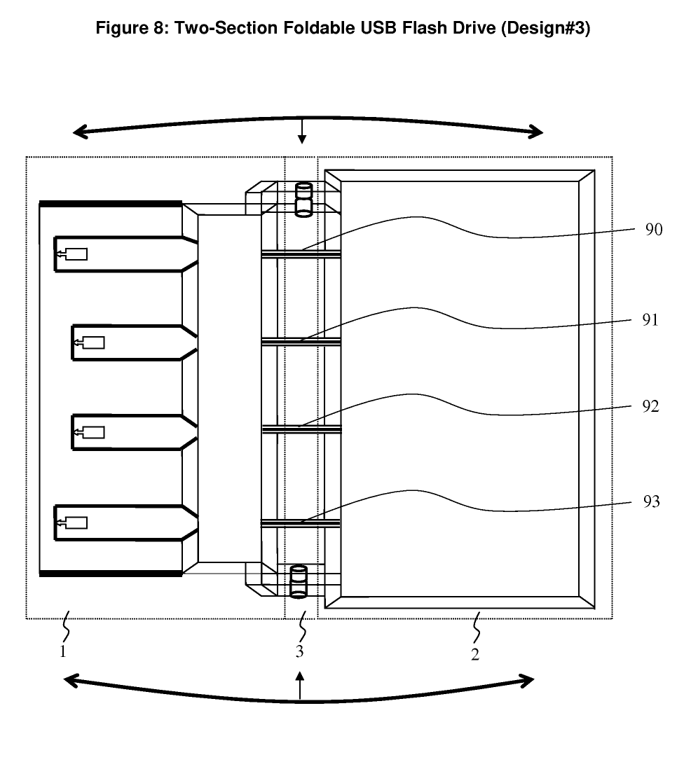

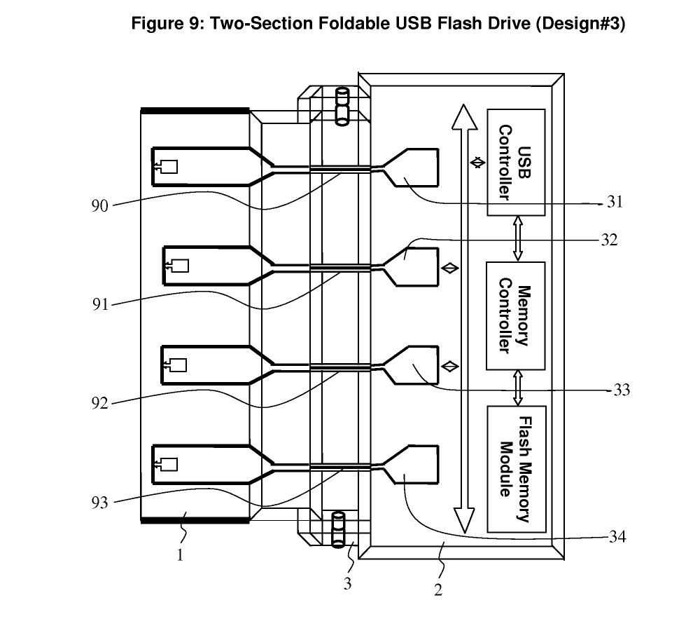

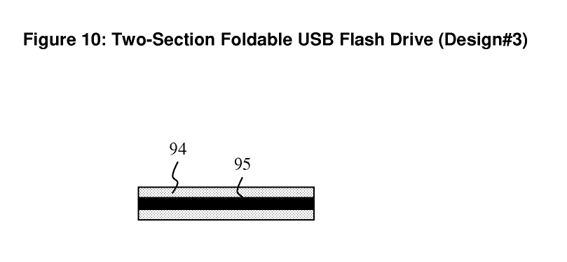

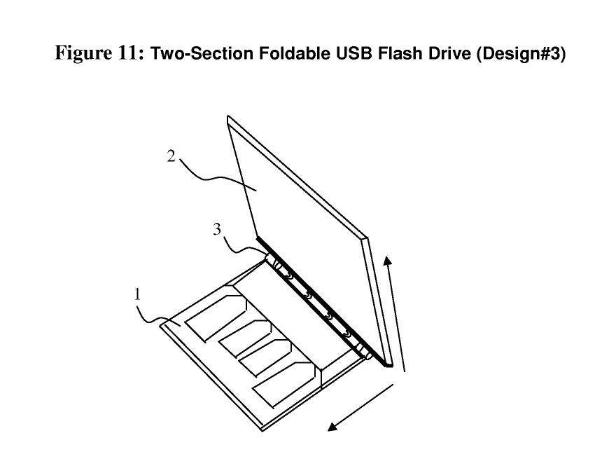

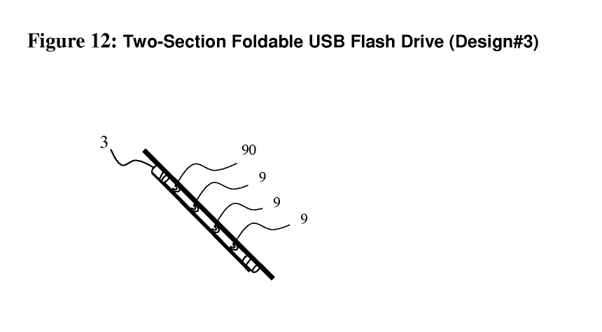

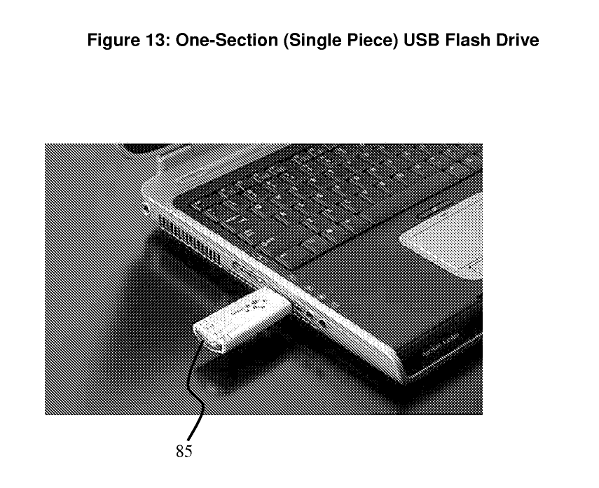

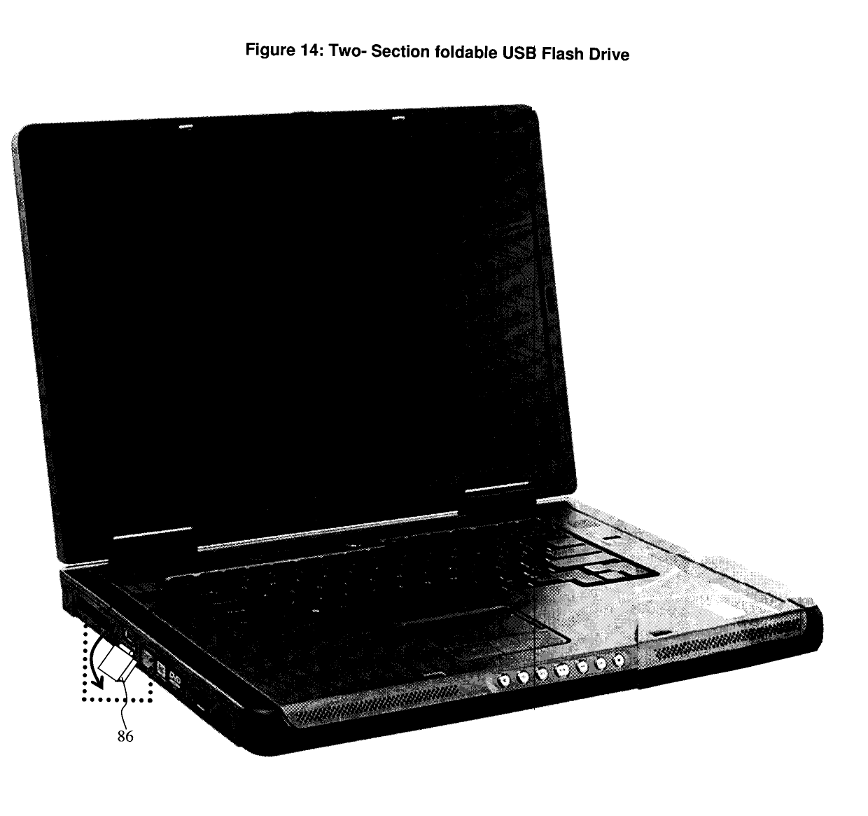

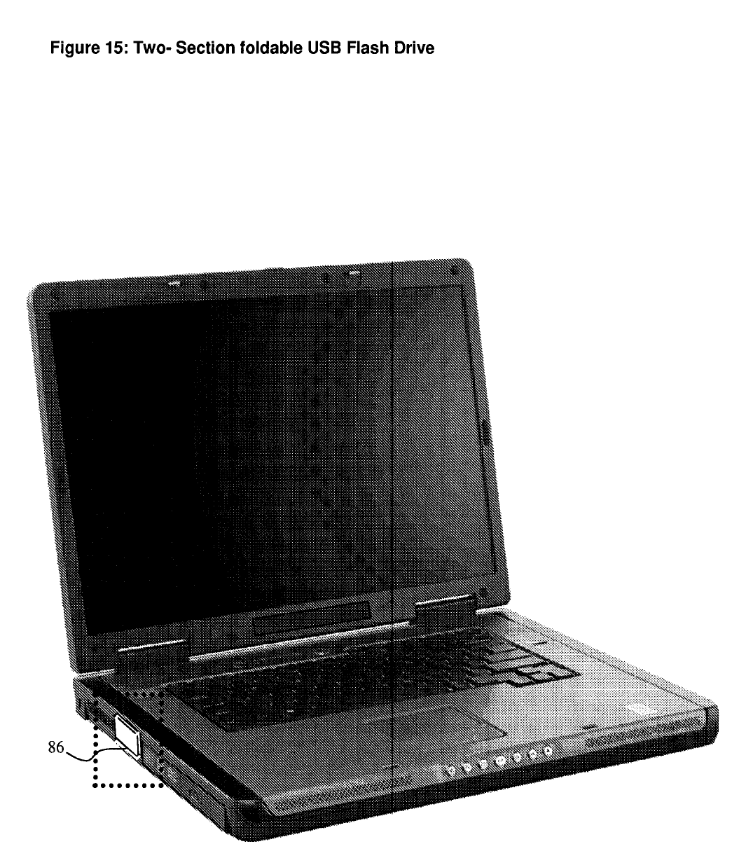

1. A USB flash memory device comprising of a USB connector, USB controller, memory controller, and at least one flash memory module, which are arranged in two separate sections to work as a unit as described below.

2. First section includes a USB connector. This section provides connectivity to USB flash memory device with the USB ports on the USB hosts.

3. Second section includes USB controller, memory controller, and at least one flash memory module. In an alternative arrangement there is a possibility of housing the USB controller in the first section that contains USB connector itself.

4. Second section is mounted on the first section on the side which is opposite to its USB connector side. Both the sections are mounted with the help of rotating hinges on two corners of each of their sides, which allow the two sections to rotate around each other and fold on to each other. Each of the sections has ability to rotate with respect to each other so that both the sections can be adjusted at any desired angle or be folded together flat on their surface.

5. a) In addition to the two corner hinges on the two sides of both the sections, there are four hinges in between the two sections. These hinges provide the standard USB connectivity between the two sections—path for required power, data transfer between the USB connecter and USB controller, and ground connection for the device. These four hinges have ability to rotate along with the corner hinges to facilitate both the sections to rotate around each other.
b) The four hinges between the two sections can be of cylindrical or ring shapes. These two cylindrical and ring hinge shapes provide two different designs for foldable USB devices.
c) Alternatively, instead of using the four hinges in between the two sections that are used for USB connectivity, flexible ribbon cables can be used to provide the standard USB connectivity between the two sections—path for required power, data transfer between the USB connecter and USB controller, and ground connection for the device. Making use of flexible ribbon cables provide an addition design for foldable USB devices. Ribbon cables are made of flexible and thin conductive wires, and the conductive wires are wrapped around by a thin film of flexible plastic material. Ribbon cables have flexibility to rotate along with the corner hinges to facilitate both the sections to rotate around each other in upward or downward directions.

6. Second section can be customized in any shape as per the availability of the free space surrounding the USB ports on USB hosts.
